(19) United States
(12) Patent Application Publication
(10) Pub. No.: US 2003/0236179 A1
(43) Pub. Date: Dec. 25, 2003

(54) Surface treating compositions and methods for using same

(75) Inventors: Jean-Francois NMN Bodet, Waterloo (BE); Mark Robert Sivik, Mason, OH (US); Jeffrey John Scheibel, Loveland, OH (US); Eugene Paul Gosselink, Cincinnati, OH (US); Michael-Vincent Nario Malanyaon, Indian Springs, OH (US); Patrice Mark Luc Borgonjon, Mariakerke (BE); Brian NMN Jeffreys, Grimbergen (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/455,195

(22) Filed: Jun. 5, 2003

Related U.S. Application Data
(60) Provisional application No. 60/386,174, filed on Jun. 5, 2002.

(51) Int. Cl. C11D 3/37

(52) U.S. Cl. 510/475

(57) ABSTRACT

Surface treating compositions and methods for using the same to treat a target surface are provided. The surface treating composition comprises a hydrophobic polymer, and is capable of delivering one or more of the following benefits: (1) the treated/rinsed surface exhibits a slip-stick transition (SST), which signals to the consumer that the surface treatment, specifically the rinse operation, is complete; (2) the surface treated with the present composition exhibits a shorter slip-stick transition time (t_{SST}) than the t_{SST} exhibited by a comparable surface treated with a composition without the hydrophobic polymer; (3) enhanced dissolution in an aqueous medium, such as water; and (4) the present composition is effective in removing grease from a soiled surface.

### CROSS REFERENCE TO RELATED APPLICATIONS

This application claims priority under 35 U.S.C. §119(e) from Provisional Application Serial No. 60/386,174, filed on Jun. 5, 2002.

### FIELD OF THE INVENTION

The present invention relates to surface treating compositions and methods for using the same to treat surfaces in need of treatment. The surface treating composition comprises a hydrophobic polymer, and is capable of delivering one or more of the following benefits: (1) the treated/rinsed surface exhibits a slip-stick transition (SST), which signals to the consumer that the surface treatment, specifically the rinse operation, is complete; (2) the surface treated with the present composition exhibits a shorter slip-stick transition time (t_{SST}) than the t_{SST} exhibited by a comparable surface treated with a composition without the hydrophobic polymer; (3) enhanced dissolution in an aqueous medium, such as water; and (4) the present composition is effective in removing grease from a surface needing treatment (i.e., a soiled surface).

### BACKGROUND OF THE INVENTION

Conventional surface treating compositions include dishwashing compositions, such as liquid hand dishwashing compositions and automatic dishwasher compositions; laundry detergents; hair care products, such as shampoos, conditioners and colorants; hard surface cleaners, such as window cleaners and bathroom cleaners; personal care products, such as shower gels and body washes; are formulated to effectively remove grease and/or soils from the treated surface. These compositions typically contain surfactants that interact with grease and/or soils, thereby removing them from the surface being treated and bring them into the wash medium. A satisfactory (i.e., clean) result is typically judged by running the consumer's hand, especially fingers, across the treated surface. A surface that offers slight and/or discontinuous resistance to the finger(s) running across it has been characterized as a “squeaky clean” surface. However, it is known that the surfactants have a tendency to adsorb onto the surface being treated and create a slippery film on the surface. Consumers typically consider the slippery surface to mean that grease, soils or other extraneous materials have not been sufficiently removed from the surface being treated, and additional rinse should be applied to achieve a satisfactory (i.e., clean) result. Consequently, consumers may spend a long time trying to rinse off the slippery film in order to ensure that the surface is thoroughly cleaned. Examples of conventional surface treating compositions are disclosed in U.S. Pat. No. 5,230,835; U.S. Pat. No. 5,389,363; PCT Publication WO 98/28393A1; and French Patent Publication FR 9,504,190A1.

There have been attempts to reduce the rinse time and still deliver the desired (i.e., “squeaky clean”) signal for cleanliness. Those attempts typically use compositions containing water-soluble surfactants that do not adsorb onto the surface being treated, thus, do not create slippery films on it. However, these formulations do not effectively remove grease.

Accordingly, it is desirable to have an improved surface treating composition that effectively removes grease and/or soils from the surface and provide a signal to the consumer that the surface being treated is clean. It is also desirable to be able to quantify the signal to the consumer that the treated surface is clean.

It is further desirable to have an improved surface treating composition that has an enhanced dissolution in the wash or rinse medium, typically water, to provide improved removeability upon rinse, resulting in a shorter rinse time is needed to reach a desired hand feel to the treated surface. An enhanced dissolution also makes preparation of the wash water or rinse water easier.

Additionally, a method for reducing the rinse time of a surface treated with this improved surface treating composition is also desirable.

### SUMMARY OF THE INVENTION

In one aspect of the invention, a surface treating composition that cleans and reduces the stick-slip transition time of a hard surface is provided. The composition comprises a hydrophobic polymer, and a surface treated by the composition exhibits a slip-stick transition time that is at least about 10% shorter than a stick-slip transition time of a control surface, which is treated by a composition without the hydrophobic polymer, as measured by the stick-slip transition test.

In another aspect of the invention, a method for reducing the rinse time of a hard surface treated with the present composition by sending the consumer a stick-slip transition signal is provided. The method comprises the following steps:

a. providing a surface treating composition comprising a hydrophobic polymer;

b. optionally, dissolving the composition in water to provide a wash liquor having at least about 3% product concentration;

c. contacting a surface needing treatment with the composition or the wash liquor; and

d. subsequently, rinsing the surface until a stick-slip transition occurs; wherein the surface exhibits a slip-stick transition time that is at least about 10% shorter than the slip-stick transition time exhibited by a control surface treated by a surface treating composition without the hydrophobic polymer, as measured by the slip-stick transition (SST) test.

### BRIEF DESCRIPTION OF THE DRAWINGS

FIG. 1 is a schematic illustration of the instrument set-up for the stick-slip transition test;

FIG. 2 an exploded view of the modified probe;

FIG. 3 illustrates the slick-slip transition of an exemplary composition of the present invention in comparison with a commercial dishwashing detergent DAWN®;

FIG. 4 illustrates the slick-slip transition of another exemplary composition of the present invention in comparison with a commercial dishwashing detergent DAWN®; and

FIG. 5 illustrates the viscosity reduction as an exemplary composition of the present composition of the present invention is diluted with water, in comparison with the viscosities exhibited by an equivalent composition without the hydrophobic polymer.

### DETAILED DESCRIPTION OF THE INVENTION

Definitions

The term “consumer signal” as used herein refers to a property or a characteristic recognized by the consumer as an indication that a satisfactory result has realized on the surface being treated or the surface being treated has received a desired benefit. For example, in the treatment of a surface, especially during or after the rinse operation, the consumer signal may be a hand feel of slip-stick transitions (i.e., a draggy feel) when the consumer moves a finger or fingers across the treated surface. The slip-stick transition is perceived by the consumer to be a signal that the treated surface is free of grease, soils orresidues from the treating composition.

The term “slip-stick transition” or “SST” as used herein means that when an object, such as a consumer's hand, especially finger(s), moves across a surface, the coefficient of friction (COF) between the object and the surface changes intermittently such that the object sticks and then slips or slips and then sticks across the surface. A slippery state typically has a low COF between about 0.02 to about 0.05. A sticky state typically has a COF of about 0.7, which is about the same COF exhibited by a thoroughly cleaned and rinsed surface under running water. The occurrence of the slip-stick transition when a consumer runs the hand or finger(s) across a treated surface would signal to the consumer that cleaning and/or rinsing of the surface is complete.

The term “slip-stick transition time” or “t_{SST}” as used herein refers to the time between the beginning of the rinse and the first occurrence of the slip-stick transition, when an object is in contact with a treated surface under rinse water. When the target surface is treated with some compositions, gradual slip-stick transitions are observed. In those cases, the t_{SST} is the time when COF of the treated surface reaches about 0.7 (i.e., the sticky state).

“Surface(s)” or “hard surface(s)” as used herein refers to any kind of surfaces typically found in houses, such as kitchens, bathrooms, or in car interiors or exteriors, including floors, walls, tiles, windows, sinks, showers, shower plastified curtains, wash basins, water closets, fixtures, fittings, and the like. Surfaces may also include dishware, such as dishes, cups, cutlery, glassware, food storage containers, cooking utensils, and the like. Additionally, surfaces may include household appliances, such as refrigerators, freezers, washing machines, automatic dryers, ovens, microwave ovens, dishwashers and the like. In addition to household surfaces, surfaces may include industrial and/or institutional surfaces. The surfaces can be made of different materials, including ceramic, vinyl, no-wax vinyl, linoleum, melamine, glass, plastics, plastified wood, metal. The surfaces also include painted or varnished or sealed surfaces, and the like.

“A treated surface” as used herein refers to a surface that has gone through a two-step treatment process. In the first step, the surface is contacted with a surface treating composition; and in the second step, the surface is exposed to a large quantity of water, such as rinse under running water or rinse in a sink full of water, to at least partially remove the surface treating composition from the surface. “A surface being treated” as used herein refers to a surface that is in either the first (contacting) step or the second (rinse) step of the treatment process.

“Percent product concentration” as used herein refers to the concentration of the surface treating composition in the wash liquor prepared according to the following recipe: x grams of the composition is mixed with (100 - x) grams of water to provide a wash liquor having x% product concentration. For example, a 3% product concentration means 3 grams of the composition is mixed with 97 grams of water.

“Average molecular weight” as used herein means the weight-average molecular weight determined by the conventional Gel Permeation Chromatography (GPC) method in chloroform solvent using polystyrene standards (Easical-PS-1, available from Polymer Laboratories, Inc.) for calibration and the units are in Daltons.

All percentages, ratios and proportions used herein are by weight, unless otherwise specified.

Surface Treating Compositions

The surface treating compositions of the present invention, may be in any suitable form, including gel, paste, liquid, granules and tablets. In certain embodiments, the surface treating composition is in the form of a concentrate in an aqueous liquid. The present invention excludes compositions, which are in the form of microemulsions.

The surface treating compositions of the present invention typically comprises an effective amount of at least one hydrophobic polymer such that a surface treated with the composition, exhibits a slip-stick transition in less than about 80 seconds, preferably less than about 70 seconds, more preferably less than about 60 seconds, and even more preferably less than about 50 seconds, after the rinse starts. In comparison, a surface treated with a composition without the hydrophobic polymer (e.g., a commercials available dishwashing detergent DAWN®) exhibits a slip-stick transition at about 90 seconds after the rinse starts. In other words, when a surface treated with the surface treating compositions of the present invention, it exhibits a shorter stick- slip transition time than when the surface is treated with a composition without the hydrophobic polymer. The reduction in stick-slip transition time is at least about 10%, preferably at least about 25%, and more preferably at least about 50%.

Moreover, a surface treated with the composition of the present invention exhibits a narrow slip-stick transition zone (i.e., a sharp slip-stick transition), which is typically less than about 2 seconds, preferably less than about 1 second and more preferably less than about 0.5 second.

Without being bound by theory, Applicants believe that the hydrophobic polymers alter the characteristics of the film covering the treated surface. When the composition of the present invention contacts the surface being treated, the hydrophobic polymer is deposited/adsorbed onto that surface, along with the surfactants and perhaps, other ingredients from the composition. The presence of the hydrophobic polymer on the treated surface interrupts the slippery film created by the deposited/adsorbed surfactants and/or other ingredients. Thus, when a user of the composition runs a finger across the surface being treated, the finger encounters low COF, slippery regions and high COF, sticky regions intermittently, which is interpreted by the user as the signal for a clean surface such that no additional rinse is needed. In contrast, a surface being treated with a composition that does not contain the hydrophobic polymer would have large regions covered by a slippery film created by the deposited/adsorbed surfactants and/or other ingredients. Thus, when a user of the composition runs a finger across the surface being treated, the finger encounters a long slip time, which corresponds to a large low COF region, before it encounters a rise in COF or a slip-stick transition, which corresponds to a region where the surfactants and/or other ingredients have been rinsed off. A user typically interprets the slippery hand feel as the signal that the surface has not been thoroughly cleaned and more washing or rinsing is needed.

It has also been found, surprisingly, that the addition of the hydrophobic polymers to a composition enhances the dissolution of the composition in an aqueous medium, such as water. The enhanced dissolution is desirable because the composition containing the hydrophobic polymer would readily dissolve in water. In contrast, the composition without the hydrophobic polymer tends to become swollen with water first, thereby increases the local viscosity and retards the dissolution process. The enhanced dissolution is beneficial when the composition is mixed with water to prepare the wash liquor for dish washing by hand. This attribute is even more beneficial during the rinse operation because the composition deposited or adsorbed on the surface being treated can dissolve in the rinse water readily, thereby shortening the rinse time.

The enhanced dissolution or the ease of dissolution can be measured by the dissolution test, which is disclosed in the Test Methods below. The composition of the present invention typically require no more than 8 rotations, preferably no more than 7 rotations, and more preferably no more than 5 rotations, to fully dissolve (i.e., becomes invisible to the naked eye).

The enhanced dissolution effect is also observed in the viscosity decreases when the composition is diluted with water. Typically, the surface treating compositions of the present invention can have a viscosity of greater than about 300 cps (0.3 Pa s), preferably greater than about 500 cps (0.5 Pa s). In some embodiments, the viscosity of the composition of the present invention can be greater than about 1000 cps (1.0 Pa s). When diluted with water, the present composition exhibits an immediate decrease in viscosity. This is quite surprising since an equivalent composition without the hydrophobic polymer would exhibit an increase in viscosity upon dilution with water, before the viscosity starts to decrease as more water is added.

Without being bound by theory, Applicants believe that the hydrophobic polymers alters the configurations of the surfactants dispersed in an aqueous medium, for example, in the wash liquor or in the rinse water. When a composition that does not contain the hydrophobic polymer is dissolved in water, the surfactants are likely to arrange themselves into a bilayered structure having the hydrophilic ends of the surfactants on the outside (i.e., water contacting side) and the hydrophobic ends of the surfactants on the inside. These bilayered structures typically assume the configurations of elongated rod-like vesicles; such elongated vesicles raise the solution viscosity. In contrast, the composition of the present invention may assume an intercalated trilayered structure having the hydrophobic polymers inserted in between the hydrophobic ends of the surfactants. These intercalated trilayered structures are likely arranged in a sheet-like macrostructure capable of holding water in between sheets of the trilayered structures, resulting in an easier and faster dissolution in water and a lower solution viscosity.

In some embodiments, the surface treating composition of the present invention may comprise at least one hydrophobic polymer at a level ranging from about 0.05% to about 15%, preferably from about 0.1% to about 10%, more preferably from about 0.2% to about 6%, and even more preferably from about 0.5% to about 5%, by weight of the composition,.

The surface treating compositions of the present invention may also comprise water. In some embodiments, water is present at a level ranging from about 30% to about 80%, preferably from about 40% to about 70%, and more preferably from about 45% to about 60%, by weight of the composition.

Adjunct ingredients that are present in a typical surface treating composition of the present invention include, but are not limited to, solvatropes, hydrotropes, viscosity modifiers, surfactants, suds stabilizing agents, diamines, carboxylic acids, magnesium ions, other optional ingredients, and mixtures thereof.

The pH of the composition of the present invention can be adjusted using any suitable pH modifying agents or buffers known in the art. In some embodiments, the pH of the present composition is adjusted to between about 4 and about 14, preferably between about 7 and about 13, and more preferably between about 7 and about 10.

Hydrophobic Polymers

Suitable hydrophobic polymers have a water solubility of less than about 1%, preferably less than about 0.5%, more preferably less than about 0.1% by weight at 25° C.

The weight-average molecular weight of the hydrophobic polymers may be from about 500 to about 50,000 daltons, preferably from about 800 to about 30,000 daltons, and more preferably from about 1,000 to about 10,000 daltons.

Moreover, suitable hydrophobic polymers may exhibit a CLogP value of greater than about 10, preferably greater than about 15, more preferably greater than about 20, but less than about 50, preferably less than about 40. In one embodiment, the ClogP value of the hydrophobic polymer in the present composition is from about 15 to about 40. In another embodiment, the ClogP value of the hydrophobic polymer in the present composition is from about 25 to about 35.

The ClogP value relates to the octanol/water partition coefficient of a material. Specifically, the octanol/water partition coefficient (P) is a measure of the ratio of the concentration of a particular polymer in octanol and in water at equilibrium. The partition coefficients are reported in logarithm of base 10 (i.e., logP). The logP values of many materials have been reported in the Pomona92 database, available from Daylight Chemical Information Systems, Inc. (hereinafter “Daylight CIS”), along with citations to the original literature. However, the logP values are most conveniently calculated by the “CLOGP” program, which is also available from Daylight CIS. This program also lists experimental logP values when they are available in the Pomona92 database. The “calculated logP” (ClogP) may be determined by the fragment approach of Hansch and Leo (cf., A. Leo, in Comprehensive Medicinal Chemistry, Vol. 4, C. Hansch, P. G. Sammens, J. B. Taylor and C. A. Ransden, Eds., p. 295, Pergamon Press, 1990). The fragment approach is based on the chemical structure of each molecule, taking into account the numbers and types of atoms, the atom connectivity, and chemical bonding. Other methods that may be used to compute ClogP include, e.g., Crippen's fragmentation method as disclosed in J. Chem. Inf. Comput. Sci., 27a, 21 (1987); Viswanadhan's fragmentation method as disclosed in J. Chem. Inf. Comput. Sci., 29, 163 (1989); and Broto's method as disclosed in Eur. J. Med. Chem. - Chim. Theor., 19, 71 (1984). It is understood by those skilled in the art that while experimental log P values could also be used, they represent a less preferred embodiment of the invention. When experimental log P values are used, the log P values at one hour are preferred.

The hydrophobic polymer may be selected from anionic, cationic, nonionic, and amphoteric polyurethanes; polyurethane-acrylics; polyurethane-polyvinylpyrrolidones; polyesters; polyester-polyurethanes; polyesteramides; fatty-chain polyesters wherein the fatty chain is at least C12, preferably C12 to C30 fatty chains; polyamide resins; polyethers; epoxyester resins; arylsulfonamide-epoxy resins; resins resulting from the condensation of formaldehyde with an arylsulfonamide; polyether-polyurethanes; polyureas and polyurea/polyurethanes.

The hydrophobic polymers may be made by any suitable process known to those of ordinary skill in the art. For example, the hydrophobic polymers can be made by polycondensation.

In some embodiments, the hydrophobic polymer is a polyester. The polyesters may be formed by polycondensation of monomers containing carboxylic acids, such as dicarboxylic acids, and monomers containing polyol, such as diols.

Nonlimiting examples of suitable dicarboxylic acids include aliphatic, alicyclic and/or aromatic dicarboxylic acids such as oxalic acid, malonic acid, dimethylmalonic acid, succinic acid, glutaric acid, adipic acid, pimelic acid, 2,2-dimethylglutaric acid, azelaic acid, suberic acid, sebacic acid, fumaric acid, maleic acid, itaconic acid, phthalic acid, dodecanedioic acid, 1,3-cyclohexanedicarboxylic acid, 1,4-cyclohexanedicarboxylic acid, isophthalic acid, terephthalic acid, diglycolic acid, thiodipropionic acid, 2,5-naphthalenedicarboxylic acid, and 2,6-naphthalenedicarboxylic acid.

Nonlimiting examples of suitable diols include aliphatic, acyclic and/or aromatic diols. Specific diols may be, but are not limited to, ethylene glycol, diethylene glycol, triethylene glycol, polyethylene glycol (PEG) such as PEG 200, PEG 300, PEG 400, 1,3-propanediol, cyclohexanedimethanol and 4-butanediol, glycerol, pentaerythritol, sorbitol and trimethylolpropane.

In some embodiments, the hydrophobic polymer may be an ethylene glycol adipate (EGA) of the formula:

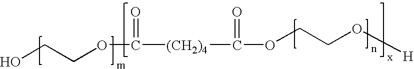

wherein n and m are independently an integer from 1 and 8, preferably from 3 to 8, and more preferably from 3 to 5; and x is an integer from 4 to 100, preferably from 10 to 50, and more preferably from 20 to 30. In one embodiment, the weight-average molecular weight of the poly(ethylene glycol adipate) or PEGA is about 8000.

In other embodiments, the polyester is formed from adipic acid and a glycol, which is selected from the group consisting of poly(triethylene glycol), poly(ethylene glycol), PEG 200, and mixtures thereof.

In yet another embodiment, the hydrophobic polymer is a polymeric glycol containing alkylene oxide moieties and has a weight-average molecular weight of at least about 500 daltons, preferably at least about 800 daltons, and more preferably at least about 1000 daltons; and less than about 10,000 daltons, preferably less than about 5000 daltons, and more preferably less than about 2000 daltons. The alkylene oxide moieties may be selected from the group consisting of ethylene oxide (EO), propylene oxide (PO), butylene oxide (BO), pentylene oxide (PeO) and hexylene oxide (HO), and mixtures thereof. These hydrophobic polymers can be made by polymerization of alkylene oxide moieties, preferably PO groups, or EO and PO, or BO groups, with initiators that are commonly used for this reaction as known in the art. In some embodiments, the ethylene oxide moieties are present in combination with another more hydrophobic moiety, such as propylene oxide or butylene oxide.

Other suitable hydrophobic polymers can be formed by adding poly(alkylene oxide) moieties to the ends of polypropylene glycols or other suitable alcohols, such as methanol.

Additionally, suitable hydrophobic polymers can be formed by reacting a mixture of alkylene oxide moieties with a suitable alcohol to form random copolymers thereof.

Adjunct Ingredients

The surface treating compositions of the present invention may also include optional adjunct ingredients. Nonlimiting examples of suitable adjunct ingredients include solvatropes, hydrotropes, viscosity modifiers, surfactants, suds stabilizing agents, diamines, carboxylic acids, magnesium ions, other optional ingredients, and mixtures thereof.

Solvatropes

A solvatrope may be present in the surface treating compositions of the present invention. Solvatrope refers to a solvent that also exhibits behavior like that of a hydrotrope. The solvatrope increases the solubility or the degree of miscibility between the various surfactant structures or phases present in the formulation. The solvatropes act as coupling agents between the surfactant structures or phases and water. Further, a mixture of the hydrophobic polymers and the solvatropes, when incorporated into the surface treating composition, prevents gelling or thickening in the initial stage of the dissolution process, i.e., when the composition is first contacted or diluted with water.

Without being limited by theory, it is believed that at certain concentrations of surfactants in water, the surfactant molecules arrange themselves into ordered (typically lamellar, spherulitic or hexagonal) surfactant phases, which cause the high viscosity in the initial stage of the dissolution process. It is believed that the hydrophobic polymers and solvatropes prevent the formation of the viscous surfactant phases from forming, because the combination of hydrophobic polymers and solvatropes can interact effectively with the surfactant molecules in the ordered structures, thereby disrupt the arrangement and promote the dispersion or formation of isotropic structures of surfactants in solution.

Solvatrope as used herein is defined as a compound having at least two polar groups separated from each other by at least 4, preferably at least 6 aliphatic carbon atoms. Examples of suitable polar groups for inclusion in the solvatrope include hydroxyl and carboxyl groups, most preferably hydroxyl groups. Particularly preferred solvatropes are selected from the group consisting of 1,4-cyclohexane dimethanol; 1,6-hexanediol; 1,7-heptanediol; and mixtures thereof. Moreover, the 1,4 cyclohexane dimethanol may be present in the cis configuration, the trans configuration, or a mixture of both configurations.

When present, the solvatrope may comprise from about 0.5% to about 10%, preferably from about 2% to about 5%, by weight of the composition.

Hydrotropes

The compositions of the present invention may comprise a hydrotrope, the definition of which can be found in S. E. Friberg and M. Chiu, J. Dispersion Science and Technology, 9(5&6), pages 443 to 457, (1988-1989). Briefly, a hydrotrope generally refers to a compound with the ability to increase the solubilities of certain slightly soluble organic compounds in an aqueous medium including water.

Nonlimiting examples of suitable hydrotopes include alkyl aryl sulfonates or alkyl aryl sulfonic acids. Specifically, the hydrotropes may include xylene sulfonic acid, toluene sulfonic acid, cumene sulfonic acid, substituted or unsubstituted naphthalene sulfonic acid, their salts with sodium, potassium, calcium or ammonium cations, and mixtures thereof. In one embodiment, the hydrotrope is a cumene sulfonate with sodium, potassium, calcium or ammonium cation. In anoter embodiment, the hydrotrope is a p-toluene sulfonate with sodium, potassium, calcium or ammonium cation.

When present, the hydrotrope may comprise from about 0.5% to about 10%, preferably from about 2% to about 8%, by weight of the composition.

Viscosity Modifiers The present compositions may comprise a viscosity modifier. Nonlimiting examples of suitable viscosity modifiers include lower alkanols, ethylene glycol, propylene glycol, ethers, amines. In one embodiment, the viscosity modifier is selected from: C1-C4 alkanols; ethers or diethers having from about 4 to about 14 carbon atoms, preferably from about 6 to about 12 carbon atoms; and more preferably from about 8 to about 10 carbon atoms; glycols; alkoxylated glycols; alkoxylated aromatic alcohols; aromatic alcohols; aliphatic branched alcohols; alkoxylated aliphatic branched alcohols; alkoxylated linear C1-C5 alcohols such as n-butoxypropanol, n-butoxypropoxypropanol; linear C1-C5 alcohols; C8-C14 alkyl or cycloalkyl hydrocarbons; halohydrocarbons; C6-C16 glycol ethers; butyl diglycol ether (BDGE); butyltriglycol ether; glycerol or propylene glycol derivatives; ether derivatives of mono-, di- and tri-ethylene glycol; butylene glycol ethers; mono-ethylene glycol n-hexyl ether; mono-propylene glycol n-butyl ether; tri-propylene glycol methyl ether; and mixtures thereof. Commercially available viscosity modifiers suitable for use herein include ethylene glycol and propylene glycol ethers available from the Dow Chemical Company under the tradename Dowanol® and from the Arco Chemical Company under the tradename Arcosolv(®); glycol ethers from Union Carbide Company under the tradename Carbitol®; and diol ethers or etheresters from Union Carbide Company under the tradename Cellosolve®. Also suitable for use here in as viscosity modifiers are mono- and di-ethylene glycol n-hexyl ether, which are available from the Union Carbide Company.

When present, the viscosity modifier comprises from about 0.01% to about 20%, preferably from about 0.5% to about 10%, and more preferably at least about 1% to about 8%, by weight of the composition.

These viscosity modifiers may be used in conjunction with an aqueous liquid carrier, such as water, or they may be used without any aqueous liquid carrier being present. Viscosity modifiers are broadly defined as compounds that are liquid at temperatures of 20° C.-25° C. and which are not considered to be surfactants. One of the distinguishing features is that viscosity modifiers tend to exist as discrete entities rather than as broad mixtures of compounds. In some embodiments, the composition of the present invention include at least one viscosity modifier selected from ethanol, propanol, isopropanol, 2-methyl pyrrolidinone, benzyl alcohol, and morpholine n-oxide.

Diamines

The surface treating compositions according to the present invention may also comprise a diamine. In the context of a hand dishwashing composition, the percentage of such diamine in the compositions can vary. Variables, such as the type and severity of the soils and stains, or the habits and practices of the users, can cause considerable variations in the wash water temperature, the volume of wash water and the length of time the dishware is contacted with the wash water.

In one embodiment, the diamines are substantially free from impurities. The term “substantially free” as used in this context means that the diamines are greater than about 95% pure, i.e., preferably greater than about 97%, more preferably greater than about 99%, still more preferably greater than about 99.5%, free of impurities. Examples of impurities which may be present in commercially supplied diamines include 2-methyl-1,3-diaminobutane and alkylhydropyrimidine. Further, it is believed that the diamines should be free of oxidation reactants to avoid diamine degradation and ammonia formation.

Diamines useful herein can be defined by the following structure:

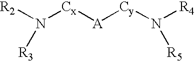

wherein R₂₋₅ are independently selected from H, methyl, ethyl, and ethylene oxides; Cₓ and C_{y} are independently selected from methylene groups or branched alkyl groups where x+y is from 3 to 6; and A is optionally present and is selected from electron donating or withdrawing moieties chosen to adjust the diamine pKa's to the desired range. If A is present, then x and y must both be 1 or greater.

Organic diamines suitable for use in the present composition have pK1 and pK2 in the range of about 8.0 to about 11.5, preferably in the range of about 8.4 to about 11, more preferably from about 8.6 to about 10.75. Nonlimiting examples of such diamines include 1,3-bis(methylamine) cyclohexane (pKa=10 to 10.5), 1,3-propane diamine (pK1=10.5; pK2=8.8), 1,6-hexane diamine (pK1=11; pK2=10), 1,3-pentane diamine (Dytek EP) (pK1 =10.5; pK2=8.9), 2-methyl 1,5-pentane diamine (Dytek A) (pK1 =11.2; pK2=10.0). Other preferred materials are the primary/primary diamines with alkylene spacers ranging from C4 to C8. In general, it is believed that primary diamines are preferred over secondary and tertiary diamines.

The surface treating compositions of the present invention may contain from about 0.1% to about 15%, preferably from about 0.2% to about 10%, and more preferably from about 0.25% to about 6%, by weight of the composition, of diamine.

Carboxylic Acids And Salts

The surface treating compositions according to the present invention may comprise a linear or cyclic carboxylic acid and salt thereof. The linear carboxylic acids and salts thereof preferably comprise from 1 to 6 carbon atoms. The cyclic carboxylic acids and salts thereof preferably comprises greater than 3 carbon atoms. The carboxylic acid or salt thereof may be unsubstituted or substituted, having a substituent selected from the group consisting of hydroxyl, ester, ether, aliphatic alkyls having from 1 to 6, more preferably 1 to 4 carbon atoms, and mixtures thereof

The carboxylic acids preferably have a pKa1 of less than about 7, more preferably from about 1 to about 3. The carboxylic acid and salts thereof may comprise one, two or more carboxylic groups.

Nonlimiting examples of suitable carboxylic acids are those selected from the group consisting of salicylic acid, maleic acid, acetyl salicylic acid, 3-methyl salicylic acid, 4-hydroxy isophthalic acid, dihydroxyfumaric acid, 1,2,4-benzene tricarboxylic acid, pentanoic acid, and mixtures thereof. Where the carboxylic acids are in the salt form, the cations of the salts are preferably selected from alkali metal cations, alkaline earth metal cations, monoethanolamine cations, diethanolamine cations or triethanolamine cations, and mixtures thereof.

The carboxylic acid or salt thereof may be present at a level of from about 0.1% to about 5%, preferably from about 0.2% to about 1% and more preferably from about 0.25% to about 0.5%, by weight of the composition.

Carboxylic acids can be used to provide improved hand feel during or after the rinse step. The presence of anionic surfactants, especially when present in higher amounts (in the range of 15-35% by weight of the composition), would impart a slippery hand feel to the surface treated with the composition containing the anionic surfactants. This feeling of slipperiness is reduced (i.e., the hand feel becomes draggy) when the surface is treated with a composition containing the above carboxylic acids and/or salts thereof. When present, the weight ratio between the anionic surfactants and the carboxylic acid and/or salts is from about 0.2: 100 to about 33: 100.

Surfactants

The compositions of the present invention may comprise a surfactant. Surfactants may be selected from the group consisting of amphoteric, zwitterionic, nonionic, anionic, cationic surfactants and mixtures thereof. Examples of suitable surfactants are given in “Handbook of Industrial Surfactants” by Ash and Ash, Endicott, N.Y. (2000).

In one embodiment, the surface treating composition comprises an amphoteric surfactant. Nonlimiting examples of the amphoteric surfactants suitable for use herein include amine oxide surfactants; amido propyl betaines; and derivatives of aliphatic or heterocyclic secondary and ternary amines, wherein the aliphatic moiety can be linear or branched and wherein at least one of the aliphatic substituents contains from about 8 to about 24 carbon atoms and at least one aliphatic substituent contains an anionic water-solubilizing group.

In another embodiment, the surface treating composition comprises an anionic surfactant. Suitable anionic surfactants include, but are not limited to, linear alkylbenzene sulfonates, alpha olefin sulfonates, paraffin sulfonates, alkyl ester sulfonates, alkyl sulfonates, alkyl sulfates, alkyl alkoxy sulfates, alkyl alkoxy caboxylates, sarcosinates, taurinates, and mixtures thereof. Specific examples of alkyl sulfate surfactants and alkyl alkoxy sulfate surfactants are disclosed in U.S. Pat. No. 6,372,708.

In yet another embodiment, the surface treating composition comprises a nonionic surfactant. Suitable nonionic detergent surfactants include, but are not limited to, amine oxides, alkyl ethoxylates, alkanoyl glucose amide, alkyl betaines, sulfobetaines, and mixtures thereof. Suitable amine oxide surfactants may include C10-C18 alkyl dimethyl amine oxides, C8-C12 alkoxy ethyl dihydroxy ethyl amine oxides, propyl amine oxides, and mixtures thereof. Other suitable nonionic surfactants are generally disclosed in U.S. Pat. No. 3,929,678, issued to Laughlin et al., on Dec. 30, 1975; U.S. Pat. No. 5,230,835, issued to Deguchi et al., on Jul. 27, 1993; and PCT Publication WO 98/28393, by Ofosu-Asante et al., published on Jul. 2, 1998.

The surfactants may be present in the surface treating compositions of the present invention in an amount from about 0.1% to about 30%, preferably from about 0.1% to about 20%, more preferably from about 0.5% to about 10%, by weight of the surface treating composition. However, as discussed above, the anionic surfactants, when present, should preferably be less than about 15%, or be in a composition that also contains carboxylic acid and/or salt thereof.

Suds Stabilizers

The compositions of the present invention may optionally contain a suds stabilizer (also referred to as “suds boosting agent” or “suds booster”). These suds stabilizers provide extended suds volume and suds duration without sacrificing the grease cutting ability of the surface treating compositions. Suitable polymeric suds stabilizers are selected from:

i) homopolymers of (N,N-dialkylamino)alkyl acrylate esters having the formula:

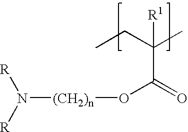

wherein each R is independently hydrogen, C₁-C₈ alkyl, and mixtures thereof; R¹ is hydrogen, C₁-C₆ alkyl, and mixtures thereof; n is from 2 to 6; and

ii) copolymers of (i) and

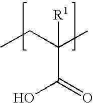

wherein R¹ is hydrogen, C1-C6 alkyl, and mixtures thereof, provided that the ratio of (ii) to (i) is from about 2:1 to about 1:2.

The weight-average molecular weight of the polymeric suds boosters, determined via conventional gel permeation chromatography, is from about 1,000 daltons to about 2,000,000 daltons, preferably from about 5,000 to about 1,000,000 daltons, more preferably from about 10,000 to about 750,000 daltons, more preferably from about 20,000 to about 500,000 daltons, even more preferably from about 35,000 to about 200,000 daltons.

The suds stabilizer can optionally be a non-polymeric compound in the form of a salt, either an inorganic or organic salt. In one embodiment, the suds stabilizer is selected from the citrate, sulfate, or nitrate salt of (N,N-dimethylamino)alkyl acrylate ester.

In another embodiment, the suds stabilizer is a polymer of (N,N-dimethylamino)ethyl methacrylate (DAMA) having the formula:

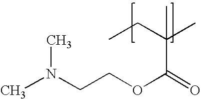

If high sudsing is desired, suds boosters such as the C10-C16 alkanolamides can be incorporated into the compositions, typically at a level of about lwt% to about lOwt% of the composition. The C10-C14 monoethanol and diethanol amides are typical of such suds boosters. Use of such suds boosters with high sudsing adjunct surfactants such as the amine oxides, betaines and sultaines is also advantageous.

When present in the compositions, the suds stabilizer may be present in the composition from about 0.01% to about 15%, preferably from about 0.05% to about 10%, and more preferably from about 0.1% to about 5%, by weight of the surface treating composition.

Other Optional Ingredients

The surface treating compositions of the present invention may further comprise one or more additional adjunct ingredients selected from the following: soil release polymers, polymeric dispersants, polysaccharides, abrasives, bactericides and other antimicrobials, tarnish inhibitors, builders, enzymes, opacifiers, dyes, perfumes, thickeners, buffers, processing aids, brighteners, anti-corrosive aids, stabilizers, antioxidants, antifungal or mildew control agents, insect repellants, and chelants.

Additional ingredients useful in formulating liquid compositions can also be included, such as carriers, solvents, and the like.

Suitable antioxidant for the present composition can be any conventional antioxidant used in detergent compositions, such as 2,6-di-tert-butyl-4-methylphenol (BHT), carbamate, ascorbate, thiosulfate, monoethanolamine (MEA), diethanolamine, triethanolamine, and the like. When present in the composition, the antioxidant comprises from about 0.001% to about 5% by weight of the composition.

Method of Treating Surfaces

The present invention also relates to a method for treating surfaces, especially hard surfaces, such as dishware, glassware, tableware, and cooking utensils. The target surface is first contacted with a composition as described above. Then, optionally, but preferably, the surface is rinsed with water before drying. Though the following describes various treatment techniques directed to dishware, it is apparent that the techniques are equally applicable to other types of surfaces.

The composition may be applied to the dishware in the neat form or in the dilute form, that is, the composition can be mixed with water in a suitable vessel, such as a basin, a sink or a bowl, to form a wash liquor or the dishwater. Moreover, the composition (neat or diluted) may be applied to the dishware via an insoluble solid support, such as a sponge, a scrubbing pad, and the like. The dishware may be contacted by the composition singly. Alternatively, a plurality of dishes can be contacted by the same wash liquor or dishwater containing the composition ot the present invention and water. In a further embodiment of the method, the composition can be used in its dilute form in a suitable vessel as a soaking medium, which is typically used for extremely dirty dishware or dishware having dried or cooked-on soils, such as remnants of food, grease or sauces, on its surface. When the dishware and the present composition are in contact, additional forces may be applied in rubbing, scrubbing, scraping, and like motions to help remove soils from the surface.

The rinse operation can be terminated when the user receives a signal (i.e., a slip-stick transition) that the surface has been cleaned.

Drying may take place passively by allowing for the natural evaporation of water or actively by using any suitable drying equipment, such as a cloth, a towel. other absorbent materials, or a heating instrument.

Test Methods

Slip-Stick Transition (SST) Test

The Slip-Stick Transition Time (t_{SST}) is the time for a treated/rinsed surface to reach a coefficient of friction of at least about 0.2, calculated from the time when the rinse starts. More detailed disclosure follows. The test uses a universal micro-tribometer (UMT), which is commercially available from Center For Tribology, Inc., Campbell, California. This Micro-Tribometer uses a modified test probe, which has a rubber tip, to determine the Slip-Stick Transition (SST) properties of the surface treating compositions of the present invention. The modified probe is placed in a sliding contact with a glass substrate surface that has been in contact with the composition and is being rinsed with water during the test. The test values may be expressed in a plot of COF-Ff (i.e., Fx/Fz) versus time (in seconds).

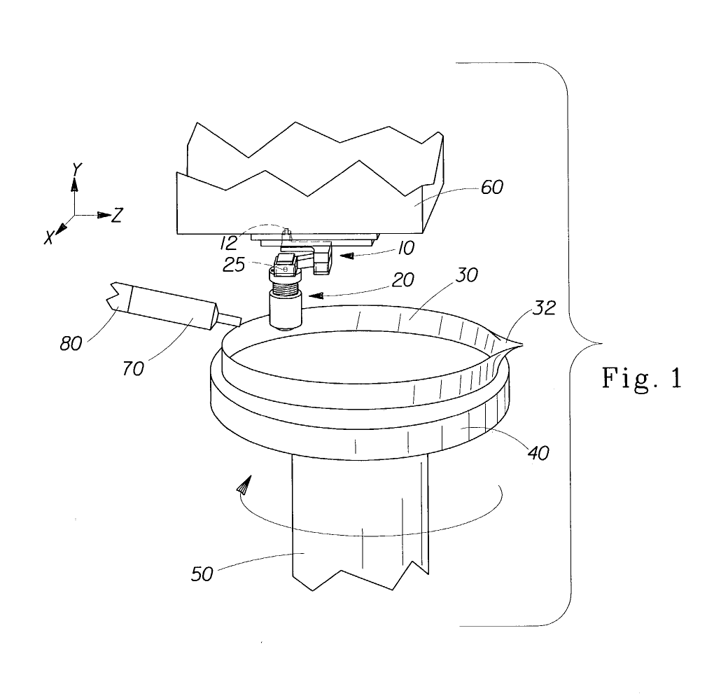

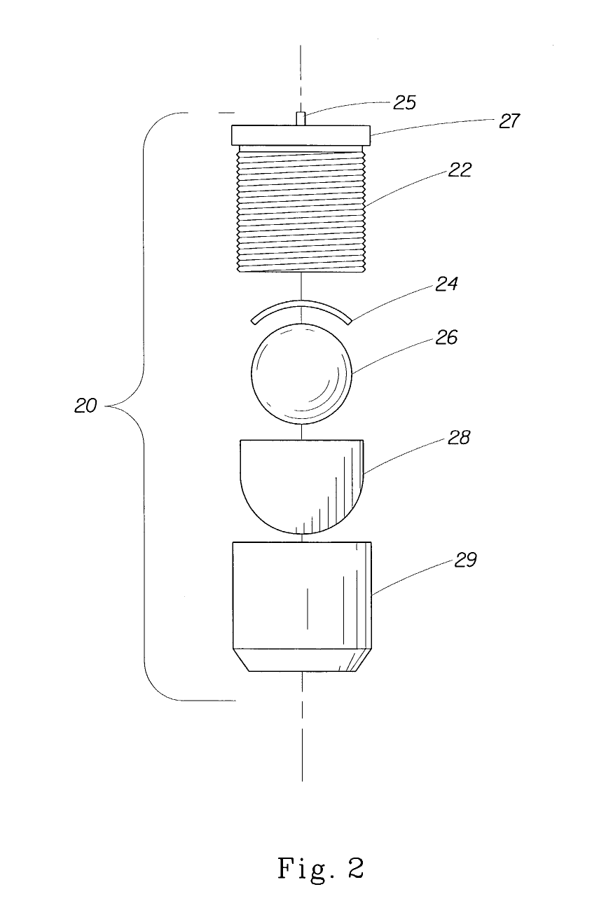

The UMT system has a testing block and a control block, which are described in detail below. Specific accessories or components of the UMT system are used to carry out the SST test are also disclosed below. Some of the components are modified. FIG. 1 and FIG. 2 illustrate how the modified components relate to one another and/or to the standard components, and will be referred to when needed to better understand the set-up of the test instrument. The standard components (such as the computer system and programs, the sensor, etc.) and their arrangement with respect to one another have been supplied by the manufacturer as part of the instrument, therefore, are not shown here.

1.A UTM Testing Block Components:

1.1 Basic System with motorized positioning, no thermal control;

1.2 Basic Encoder;

1.3 Torque Rotational Motion Drive 50 (Medium)—Model SHHME (speed 0.1 to 5,000 rpm, maximum load 20 kg (0.2 kN), medium torque);

1.4 2-axis Friction/Load Sensor—Model FVL (Range: 1 to 100 mN);

1.5 Mounting Extension Block 60, which houses the sensor and suspensions for the sensor;

1.6 Modified Probe 20, which includes a ball holder 29 having interior threads, screw 22 having mating exterior thread and a stainless steel ball 26 (about ¾ inch or 19 mm in diameter and available from the manufacturer of this instrument); the ball 26 of the Modified Probe 20 (as shown in FIG. 2) is modified by covering the lower surface (i.e., the surface that partially protrudes from the bottom of the probe) of ball 26 with a rubber tip 28, and the upper surface of ball 26 with a piece of spacer 24; when screw 22 is tightened together with the ball holder 29, the ball 26, the rubber tip 28 and the spacer 24 are secured inside the Modified Probe 20; the rubber tip 28 is cut from the fingertip portion of a nitrile glove (VWR Scientific Products, Catalog No. 40101-440, MicroGrip, extra-small); the spacer 24 is made from a sheet of Class VI medical-grade silicone rubber sheet (available for McMaster-Carr, Catalog No. 109, Product No. 87315K62); the screw 22 has a protrusion 25 extending outwardly from the cap of screw 21;

1.7 Suspension Holder 10, which has a recess (not shown) on its lower surface, the protrusion 25 of screw 22 can be snuggly fitted into said recess, thereby securing the Modified Probe 20 to Suspension Holder 10; the Suspension Holder 10 also has a shaft 12 extending upward from the Suspension Holder 10 that can be snuggly fitted into a hole (not shown) in the bottom of the Sensor, which is housed inside the Mounting Extension Block 60; and

1.8 Specimen Table 40, which sits on top of the Torque Rotational Motion Drive 50, and is attached thereto using a double sided adhesive tape.

1.B UTM Control Block:

1.9 The control block is a computer-based unit with data acquisition and computerized motor controllers for vertical and lateral positioning/movements of the probe, the associated holder and sensor described above.

1.C Accessories

1.10 Pyrex® Brand Petri Dish 30 (available from VWR Scientific Products, Catalog No. 25354-025, Corning No. 3160-60, 95 mm in diamter and 15 mm in wall height), which is fastened, on its bottom side, with a double sided tape (not shown) to the Specimen Table 40. The Petri dish 30 is modified with a spout 32 to guide the overflow of rinse water into a catch tray (not shown) 1.11 Syringe 70 (5 cc, available from VWR Scientific Products) 1.12 Separatory Funnel (2 liter, also available from VWR Scientific Products) 1.13 Monostat Veristaltic Pump (Advanced Model, available from VWR Scientific Products) 1.14 ¼ inch (6.35 mm) diameter Tygon® tubings (available from VWR Scientific Products) for connecting Accessories 1.11 to 1.12 to 1.13

2. Micro-Tribometer Sensor Calibration

2.1 Use an extension cable to connect the sensor of the testing block to the control block.

2.2 Go to menu “Options/Edit” and select “Data Acquisition/Ranges/Force”.

2.3 Set Fx, Fy, and Fz limits to 500 mN (milliNewtons), and click “OK.”

2.4 Insert the square shaft of the Suspension Holder into square hole in the Sensor. Tighten the screw so that the Suspension Holder is secured to the Sensor.

2.5 For Fz calibration, program the Sensor/Probe combination to move horizontally (i.e., the left-right direction, from the perspective of the operator) along the z-axis on a flat horizontal plane (which is defined by the x and z axes). Adjust “Zero Fz” knob on the mounting Extension block with a small flat-headed screwdriver until the Fz reading is about zero on the computer screen. Close the “Semi-automatic Panel” screen.

2.6 Record the zero reading of normal force as “Fz0”. Use numeric readings from “Automatic Panel” screen (in mN).

2.7 Put a 20 grams (200 mN) weight on top of holder (adjust the position of the weight so that it is centered). Record the force reading corresponding to 200 mN load as “Fz1”. (For example, Fz0=−0.13 mN; Fz1=−192.48 mN).

2.8 Calculate real force limit: FzL=100000/(abs(Fz1—Fz0)). (Example: FzL=100000/abs(−192.48+0.13))=100000/192.35=519.89 mN. Note the same procedure can be used for calibration with any available weight (from 10 to 40 grams); the real force limits can be calculated as follows: FL=(FL0*L)/(abs(F1-F0)), wherein FL0 is the initial force limit from “Options/Edit” menu, L is the real load used (i.e., the calibration weight of step 2.7 above), and F0, F1 correspond to the force reading before and after loading, respectively (see steps 2.6 and 2.7 above).

2.9 Close “Automatic Panel” screen. Go to menu “Options/Edit” and select “Data Acquisition/Ranges/Force.”

2.10 Enter calculated force limit for Fz (see step 2.8). Click “OK” to close “Options” screen.

2.11 Go to menu “Options/Save” screen and save the current settings.

2.12 To check the calibration, put the weight (from step 2.7) on top of the holder, then remove it; take readings with and without the weight. The difference in readings with and without the weight should be close to 200 mN.

2.13 For Fx calibration, program the Sensor/Probe combination to move vertically (i.e., the near/far direction, from the perspective of the operator) along the x-axis on a flat horizontal plane. Open “Automatic Panel” screen and adjust “Zero Fx.”

2.14 Repeat 2.5-2.11, except the weight is now placed on the edge (i.e., off-centered) of the holder, and the calculated force limit is entered as Fx in “Options” screen.

3 Micro-Tribometer Parameter Set-up

3.5 Go to “File/New/Sequence” screen and enter a filename, then go to “Sheets” screens.

3.6 On “Sheet 1” program in the following test parameters: Fz=−25 g; T=10 sec

Carriage Set Up:

Force (Fz): constant force

From: −25

Duration: 10 second

Spindle Set Up:

Move: Continous

Velocity: 0 revolution/min

Direction: Clockwise

Slider Set Up:

Velocity (working): manually enter the desired mm/sec

Velocity (initial positioning): 2 mm/sec

Position (referring to the starting position): Idle, mm

Initial: 30

wherein the “Carriage” programs the movement (i.e., raising and/or lowering) of the Mounting Extension Block 60 which houses the Sensor inside; “Spindle” programs the rotational movement of the Specimen Table 40 via the Torque Rotational Motion Drive 50 that drives it; and “Slider” programs the movements of the Modified Probe 20, and further wherein the “working velocity” program the total distance (along the z axis in this instance) to be traveled by the Modified Probe 20 during the test and the “initial positioning velocity” programs the rate of movement of the Modified Probe 20 during the test.

3.7 Sheet 2: Fz=−25 g; T=4 min

Carriage Set Up:

Force (Fz): constant force

From: −25

Duration: 4 min.

Spindle Set Up:

Move: Continous (when the revolution starts, make sure that the spindle moves immediately, i.e., without hesitation or sluggishness; if not, start over)

Velocity: 40 revolutions/min

Direction: Clockwise

Slider Set Up:

Velocity (working): manually enter the desired mm/sec

Velocity (initial positioning): 2 mm/sec

Position(refers to starting position): Idle, mm

Initial: 30

4 Micro-Tribometer Rinse Set-up

4.1 Provide a 5 gallon bucket filled with 2 gpg water, which serves as the rinse medium. The “gpg” unit as used herein refers to the hardness of water; “2 gpg” means there is 2 grains of CaCO₃ per gallon of water. Water having other known hardness can also be used in this test.

4.2 Use a ¼ inch (6.35 mm) diameter Tygon® tubing to connect a Monostat Veristaltic Pump to a standard 2 Liter Separatory Funnel; the separator funnel acts as a reservoir for the rinse water and controls the flowrate during the rinse process by adjusting its stopper.

4.3 Use another ¼ inch (6.35 mm) Tygon® tubing to connect the Separatory Funnel to a 5 cc syringe.

4.4 Fill the Separatory Funnel using the Monostat Veristaltic Pump.

4.5 The flow rate of the rinse water is calibrated before starting the automated test as programmed above. The stopper of the Separatory Funnel is fully opened to allow the rinse water to flow through the rinse set up. Catch the effluent from Syringe 70 with a calibrated cylinder in a set time and calculate the flow rate. The flow rate is about 150 ml/min.

5 Micro-Tribometer Test Set-up

5.1 Direct the tip of Syringe 70 to the peripheral portion (about 2 mm from the edge) of the Petri dish 30, as shown in FIG. 2.

5.2 Position the Modified Probe to contact the glass surface at about 15 mm radius from the edge of the Petri dish 30, as shown in FIG. 2.

5.3 Calibrate the Modified Probe 20. The calibration runs through steps 5.4-5.10 described below, and a blank (i.e., water without a surface treating composition) or a calibration sample with a known SST value is injected in step 5.5.

5.4 Lower the Modified Probe 20 to a clearance (in height) of 3 mm from the Petri dish 30.

5.5 Inject 4 cc of a test sample having 3% product concentration into the Petri dish 30; “3% product concentration” means 3 grams of the composition is diluted with water (97 grams) to make a 100 grams mixture.

5.6 Fill the Separatory Funnel using the Monostat Veristaltic Pump.

5.7 Highlight parameters and press “Play” button to begin the test. The “Prompt” menu will ask for a filename for the test data. Enter the desired filename.

5.8 As programmed above, the first sequence of the test (Sheet 1) is the idle mode, which lasts about 10 seconds. Once the instrument initiates the second sequence (Sheet 2), start the timer for about 50 seconds. This is the equilibrium stage for the sample. After about 50 seconds, the equilibrium is established.

5.9 At about 60 seconds from the beginning of step 5.8, manually open the stopper in the Separatory Funnel and begin the rinse. The entire test (including the idle time and the equilibrium time) lasts for about 4 minutes, unless the sequence parameters in Sheet 2 are programmed otherwise.

5.10 Turn off the stopper after the test sequences have been completed. Clean the Petri dish 30 with water and methanol and wipe the Petri dish 30 dry before starting the next run.

5.11 Repeat steps 5.4-5.10 for other samples.

5.12 Calibrate the rubber tip 28 in the Modified Probe 20 often and replace it when necessary.

Measurements are taken in the entire first and second sequences for both control and test sample. The instrument automatically calculates COF-Ff (which is the ratio Fx/Fz) from the measurements of Fz and Fx and plot COF-Ff against time. The Slip-Stick transition (SST) is indicated by a sharp rise followed by a plateau in the plot. The plateau COF value is about the COF value of the blank—with water in the Petri dish, which is representative of a clean dish. The Slip-Stick Transition Time (t_{SST}) is the difference (i.e., delta) bewteen the time when the rinse starts (i.e., 60 seconds from the beginning of the test) and the time when the sharp rise in the COF reaches the plateau. The average t_{SST} from 3 runs of a given sample is reported. It is recognized that each run reports a COF that is an average value of raw data, which oscillate about the average COF value.

Dissolution (or Solubilization) Test

The dissolution of the surface treating compositions of the present invention may be measured using a cylinder dissolution test. The cylinder dissolution test measures the extent of agitation is required for a composition to dissolve in a fixed quantity of water. Dissolution of the composition is achieved when it can no longer be seen in the cylinder by naked eyes from a distance of about one foot (30.5 cm) against a white background (e.g., a white printer paper).

For this test, 0.6 mL of the composition, dyed dark blue with 1 drop (about 0.2 ml) of an aqueous solution of 0.05% Blue No. 1 dye for visibility, is squirted into a cylinder containing 500 mL of water at 35° C. with a hardness of 15 gsg. The cylinder is then mounted on a motorized table and rotated through one full circle (360°) at about 22 rpm. At the end of each successive rotation (i.e., a 360° full circle), the cylinder is checked for visibility of the composition. The cylinder is rotated, one full circle at a time, until the composition is no longer visible. The number of rotations necessary for the composition to become invisible is noted. The composition is considered to be fully dissolved when the stained composition is no longer visible to the naked eyes.

Viscosity Test

The viscosity of the surface treating compositions of the present invention can be measured on a Brookfield viscometer model # LVDVII+ at 20° C. The spindle used for these measurements is S31 with the appropriate speed to measure products of different viscosities; e.g., 12 rpm to measure products of viscosity greater than about 1000 cps (1 Pa s); 30 rpm to measure products with viscosities between about 500 cps (0.5 Pa s) and about 1000 cps (1 Pa s); 60 rpm to measure products with viscosities less than about 500 cps (0.5 Pa s).

### EXAMPLES

The following examples are illustrative of the present invention, but are not meant to limit or otherwise define its scope.

| | 1A | 1B | 1C | 1D | 1E | 1F |
|---|---|---|---|---|---|---|
| Example | Wt % | Wt % | Wt % | Wt % | Wt % | Wt % |
| Hydrophobic | 0.5 | 0.5 | 3.0 | 3.0 | 7.0 | 12.0 |
| Polymer | | | | | | |
| Solvatrope | 1.5 | 1.5 | 3.0 | 3.0 | 3.0 | 3.0 |
| Solvent | 0 | 0 | 1.0 | 1.0 | 6.5 | 7.0 |
| Ethanol | 5.0 | 5.0 | 2.15 | 2.15 | 0 | 1.0 |
| NaCl | 1.0 | 1.0 | 1.2 | 1.2 | 0.8 | 1.3 |
| Hydrotrope | 0 | 0 | 2.0 | 2.0 | 0 | 2.0 |
| Amine Oxide | 6.5 | 6.5 | 6.5 | 6.5 | 6.5 | 6.5 |
| Surfactant | | | | | | |
| Nonionic | 3.0 | 3.0 | 3.0 | 3.0 | 3.0 | 3.0 |
| Surfactant | | | | | | |
| Anionic | 27.0 | 27.0 | 27.0 | 27.0 | 27.0 | 27.0 |
| Surfactant | | | | | | |
| Diamine | 0.0 | 0.0 | 0.5 | 0.5 | 0.0 | 0.5 |
| Magnesium Ion | 0.0 | 0.1 | 0.0 | 0.1 | 0.0 | 0.0 |
| Suds Boosting | 0.2 | 0.2 | 0.2 | 0.2 | 0.2 | 0.2 |
| Polymer | | | | | | |
| Enzyme | 0.1 | 0.1 | 0.0 | 0.0 | 0.01 | 0.0 |
| Water | Balance | Balance | Balance | Balance | Balance | Balance |
| pH @ 10% | 9 | 9 | 9 | 9 | 9 | 9 |

### Example 2

An exemplary composition of the present invention is prepared and diluted with water to a 3% product concentration, then tested according to the SST test described above. The composition contains: 2 wt % hydrophobic polymer—poly(triethylene glycol adipate) or PTEGA; 4.5 wt % ethanol; 0.8 wt % NaCl; 6.5 wt % amine oxide surfactant; 3.0 wt % nonionic surfactant -C₁₀E₈ alkyl ethoxylate (decanol with an ethoxylation of 8); 27 wt % anionic surfactant—Na alkylethoxylate (0.6) sulfate; 0.5 wt % diamine—1.3-bis(aminomethyl cyclohexane); 0.2 wt % suds boosting polymer—poly(dimethyl aminoethyl methacrylate) or DMAM; balance of water; and pH buffered to 9.

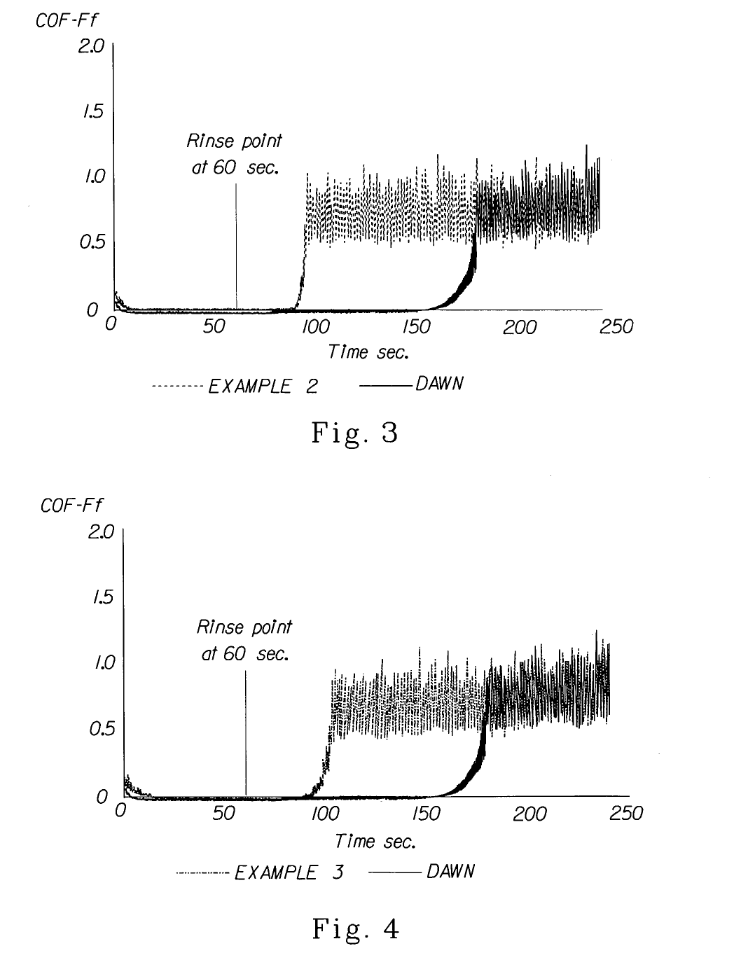

In FIG. 3, the t_{SST} of Example 2 is compared with the t_{SST} for a commercial dish washing composition DAWN®, which does not contain a hydrophobic polymer. It is apparent that the t_{SST} of Example 2 of the present invention is significantly shorter than the t_{SST} of a commercial composition DAWN®.

### Example 3

Another exemplary composition of the present invention is prepared and diluted with water to a 3% product concentration then tested according to the SST test described above. The composition contains: 2 wt % hydrophobic polymer—poly(butylenes glycol) or PBG; 4.5 wt % ethanol; 0.8 wt % NaCl; 1.6 wt % hydrotrope—sodium cumene sulfonate; 6.5 wt % amine oxide surfactant; 3.0 wt % nonionic surfactant—a decanol having an ethoxylation of 8; 27 wt % anionic surfactant—Na alkylethoxylate (0.6) sulfate; 0.5 wt % diamine—1,3-bis(aminomethyl cyclohexane); 0.2 wt % suds boosting polymer—poly(dimethyl aminoethyl methacrylate) or DMAM; balance of water; and pH buffered to 9.

FIG. 4 similarly shows a shorter t_{SST} of Example 3 as compared to the t_{SST} of a commercial composition DAWN®.

### Example 4

Compositions of Example 2 are prepared, diluted and tested, including (i) as is (i.e., the undiluted composition); (ii) diluted to 80% product concentration (i.e., 80 grams of composition mixed with 20 grams of water); and (iii) diluted to 60% product concentration (i.e., 60 gams of compostion mixed with 40 grams of water). Control samples, which are almost identical to Example 2, but without the hydrophobic polymer therein, is also prepared, diluted and tested with the same product concentrations.

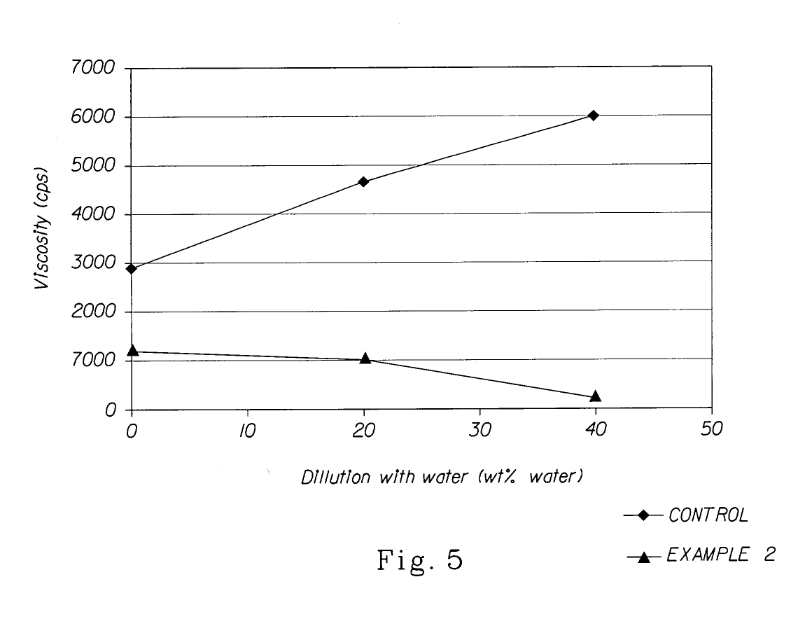

FIG. 5 shows the solution viscosities vary with product concentrations. Example 2 of the present invention exhibits a lower solution viscosity than that of the control samples in the product concentration range of about 60% or higher. Further, Example 2 of the present invention exhibits a decrease in solution viscosity upon dilution, whereas the control (which contains no hydrophobic polymers) exhibits a solution viscosity increase upon dilution, in the product concentration range of about 60% or higher.

All documents cited are, in relevant part, incorporated herein by reference; the citation of any document is not to be construed as an admission that it is prior art with respect to the present invention.

While particular embodiments of the present invention have been illustrated and described, it would be apparent to those skilled in the art that various other changes and modifications can be made without departing from the spirit and scope of the invention. It is therefore intended to cover in the appended claims all such changes and modification that are with in the scope of this invent ion.

What is claimed is:

1. A surface treating composition that cleans and reduces the stick-slip transition time of a hard surface, wherein
said composition comprises a hydrophobic polymer; and
a stick-slip transition time of a treated surface, which is the hard surface treated by said composition, is at least about 10% shorter than a stick-slip transition time of a control surface, which is treated by a composition without the hydrophobic polymer, as measured by the stick-slip transition test.

2. The composition according to claim 1 wherein the treated surface exhibits a slip-stick transition time of less than about 80 seconds.

3. The composition according to claim 1 wherein the composition exhibits a decrease in viscosity when diluted with water to a product concentration of about 60% or higher.

4. The composition according to claim 1 wherein the hydrophobic polymer has one or more of the following properties:
(a) a ClogP value of greater than about 10;
(b) a weight-average molecular weight of from about 500 to about 50,000; and
(c) a solubility in water of less than about 1 wt % at 25° C.

5. The composition according to claim 1 wherein the hydrophobic polymer has a ClogP value of from about 15 to about 40.

6. The composition according to claim 1 wherein the hydrophobic polymer is a polycondensate selected from the group consisting of anionic, cationic, nonionic, and amphoteric polyurethanes; polyurethane-acrylics; polyurethane-polyvinylpyrrolidones; polyesters; polyester-polyurethanes; polyesteramides; fatty-chain polyesters; polyamide resins; polyethers; epoxyester resins; arylsulfonamide-epoxy resins; resins resulting from the condensation of formaldehyde with an arylsulfonamide; polyether-polyurethanes; polyureas and polyurea/polyurethanes and mixtures thereof.

7. The composition according to claim 6 wherein the hydrophobic polymer is a polyester derived from a dicarboxylic acid and a diol, wherein the dicarboxylic acid is selected from the group consisting of: oxalic acid, malonic acid, dimethylmalonic acid, succinic acid, glutaric acid, adipic acid, pimelic acid, 2,2-dimethylglutaric acid, azelaic acid, suberic acid, sebacic acid, fumaric acid, maleic acid, itaconic acid, phthalic acid, dodecanedioic acid, 1,3-cyclohexanedicarboxylic acid, 1,4-cyclohexanedicarboxylic acid, isophthalic acid, terephthalic acid, diglycolic acid, thiodipropionic acid, 2,5-naphthalenedicarboxylic acid, 2,6-naphthalenedicarboxylic acid, and mixtures thereof; and the diol is selected from the group consisting of: ethylene glycol, diethylene glycol, triethylene glycol, polyethylene glycol, 1,3-propanediol, cyclohexanedimethanol and 4-butanediol, glycerol, pentaerythritol, sorbitol, trimethylolpropane, and mixtures thereof.

8. The composition of claim 1 wherein the hydrophobic polymer comprises a glycol moiety or an adipate moiety.

9. The composition according to claim 1 wherein the hydrophobic polymer is poly(triethylene glycol adipate) or poly(ethylene glycol adipate).

10. The composition according to claim 1 wherein the hydrophobic polymer has the formula: 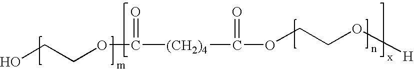
wherein m and n are independently an integer from 1 to 8, and x is an integer from 4 to 100.

11. The composition according to claim 1 wherein the hydrophobic polymer is a polymeric glycol selected from the group consisting of: polypropylene glycol, polybutylene glycol, polypentalyene glycol, polyhexylene glycol and mixtures thereof.

12. The composition according to claim 1 further comprising adjunct ingredients selected from the group consisting of: soil release polymers, polymeric dispersants, polysaccharides, abrasives, bactericides and other antimicrobials, tarnish inhibitors, builders, enzymes, opacifiers, dyes, perfumes, thickeners, buffers, processing aids, brighteners, anti-corrosive aids, stabilizers, antioxidants, antifungal or mildew control agents, insect repellants, chelants, and mixtures thereof.

13. A method for treating a hard surface and reducing the rinse time via a stick-slip transition signal comprising the steps of:
a. providing a surface treating composition comprising a hydrophobic polymer;
b. optionally, dissolving the composition in water to provide a wash liquor having at least about 3% product concentration;
c. contacting a target surface with the composition or the wash liquor; and
d. subsequently, rinsing the surface until a stick-slip transition occurs; wherein the surface exhibits a slip-stick transition time that is at least about 10% shorter than the slip-stick transition time exhibited by a control surface treated by a surface treating composition without the hydrophobic polymer, as measured by the slip-stick transition (SST) test.

14. The method according to claim 13 wherein during step (d) the surface exhibits a slip-stick transition time of less than about 80 seconds.

15. The method according to claim 13 wherein the hydrophobic polymer comprises a glycol moiety or an adipate moiety.

16. The method according to claim 15 wherein the hydrophobic polymer is selected from the group consisting of poly(triethylene glycol adipate); poly(ethylene glycol adipate); polyglycols; a polyester having the formula: 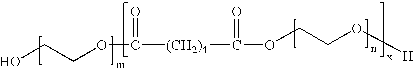
wherein m and n are independently an integer from 3 to 8, and x is an integer from 4 to 100; and mixtures thereof.

17. The method according to claim 13 wherein the hydrophobic polymer has one or more of the following properties:
(a) a ClogP value of greater than about 10;
(b) a weight-average molecular weight of from about 500 to about 50,000; and
(c) a solubility in water of less than about 1 wt % at 25° C.

18. The method according to claim 13 wherein step (c) comprises applying the composition to the target surface directly, via an insoluble solid support, or in the form of a wash liquor.

19. A surface treated by the method according to claim 13.

20. The use of a hydrophobic polymer in a surface treating composition to reduce the rinse time via a stick-slip transition signal according to the method of claim 13.
